(19) United States
(12) Patent Application Publication
(10) Pub. No.: US 2026/0119808 A1
(43) Pub. Date: Apr. 30, 2026

(54) GRACEFUL TRANSFER OF CALL OR TEXT CONVERSATION FROM ARTIFICIAL INTELLIGENCE AGENT TO HUMAN AGENT

(71) Applicant: Marr Labs Technologies, Inc., Lafaytee, CA (US)

(72) Inventor: Han Shu, Lafayette, CA (US)

(21) Appl. No.: 19/314,756

(22) Filed: Aug. 29, 2025

Related U.S. Application Data
(60) Provisional application No. 63/690,497, filed on Sep. 4, 2024.

(51) Int. Cl. G06F 40/35; G06F 40/289; G06F 40/40; H04M 3/523

(52) U.S. Cl. CPC G06F 40/35; G06F 40/289; G06F 40/40; H04M 3/523; H04M 2201/405; H04M 2203/404

(57) ABSTRACT

A human and a first AI agent are connected in a conversation which may be spoken (via telephone call) or via text (such as in a mobile or other messaging application). Keywords or phrases identified from the conversation are then compared to entries in an intent database to identify (a) an intent of the human indicating why they joined the conversation. (b) a necessity for involving a second agent in the conversation; and/or (c) based on the intent, which of several other agents are an appropriate match for the second agent. The second agent is then gracefully involved in the conversation by ensuring the human is continuously engaged until the second agent is available.

### CROSS REFERENCE TO RELATED APPLICATIONS

This application claims priority to a co-pending U.S. Provisional Patent Application Ser. No. 63/690,497 filed Sep. 4, 2025 entitled “Graceful Transfer of Call or Text Conversation with Artificial Intelligence Agent to Human Agent”, the entire contents of which are hereby incorporated by reference.

### BACKGROUND

A traditional location known as a call center is an office where a large number of agents provide customer service over the telephone. Inbound call centers receive calls for customer support that are initiated by customers and prospects and often serve as a knowledge base for tech support, billing questions, and other customer service issues. These call centers focus on quick call resolution times and agent productivity. In outbound call centers, agents make calls rather than receive them. These could be sales calls, marketing offers, surveys, fundraising requests, or debt collection, for example.

The current use of the term “contact center” reflects the reality that there are many other ways to connect with customers besides the telephone such as text or chat applications. The combined trends of increased customer expectations and newer technologies allow for many different channels of communication are creating a shift in the traditional call center model which has existed for decades. Consumers want more ways to reach businesses, and businesses are looking for new ways to improve the customer experience.

Emerging methods reduce agent effort and improve customer experience leverage artificial intelligence (AI). AI agents can provide contact centers with mechanisms to reduce agent effort, improve quality and reduce costs by minimizing search and data entry tasks.

### BRIEF SUMMARY

According to the teachings herein, an Artificial Intelligence (AI) Agent interacts with a human via voice, chat, or a combination, in such a way that mimics natural conversation. The AI Agent understands when they cannot fulfill the request of the human and either initiates a so-called “graceful” transfer to another AI agent or another human agent. The AI Agent may determine which available AI or human agent—a “second agent” would best handle the request of the human caller, and notify that second agent that they are needed. The second agent can be given a summary of the conversation prior to the second agent joining the conversation. If a second AI agent is not available for a timely transfer, the initial AI Agent may continue the conversation with the human until the addition of a human agent to the conversation can be completed.

As such, a method or apparatus may connect a human and a first AI agent in a conversation. The conversation may be spoken (via telephone call) or may be via text (such as in a short message or other messaging application). Next, keywords, phrases, or other semantic elements are identified from the conversation. These semantic elements are then analyzed to determine an intent of the caller. This analysis seeks to identify (a) an intent of the human indicating why they joined the conversation. (b) a necessity for involving a second agent in the conversation; and/or (c) based on the intent, which of several other agents are an appropriate match for the second agent.

In a case where the conversation is spoken, an audio signal from the conversation may be converted into text before identifying the keywords or phrases.

In some scenarios, adding the second agent may “gracefully” proceed as follows. For example, before the appropriate second is identified and available, the first AI agent continues to interact with the human in the conversation. Continuous interaction between the initial AI agent and the human ensures that the human is always engaged, in such a way to mimic natural conversation until the second agent is available.

The second agent may be a human or another AI agent.

Other features of the methods and systems are evident from the detailed description that follows.

### BRIEF DESCRIPTION OF THE DRAWINGS

FIG. 1 is a process diagram illustrating how to determine when to Transfer a Voice Conversation to a Human Agent.

FIG. 2 is a process diagram illustrating how to determine when to Transfer a Voice Conversation to a Human Agent with Speech.

FIG. 3 is a process diagram illustrating how to determine when to Transfer a Text Conversation to a Human Agent.

FIG. 4 is a process diagram illustrating how to determine when to Add a Human Agent to a Voice Conversation.

FIG. 5 is a process diagram illustrating how to determine when to Add a Human Agent to a Text Conversation.

FIG. 6: is a process diagram illustrating how to determine an Intent of a Human Agent to Transfer a Conversation Back to an AI Agent,

FIG. 7 is a process diagram illustrating a Graceful Transfer Process of a Conversation from an AI Agent to a Human Agent.

FIG. 8 is an example of a system environment that may be used to implement the processes described herein.

### DETAILED DESCRIPTION

The systems and methods described herein utilize an AI Agent to interact with a human via voice, chat, or combination thereof, in such a way as to limit the use of a human agent who would be more costly to utilize. Additionally, the AI Agent can transfer the conversation to a human agent in a graceful manner when needed.

In one common scenario, the conversation is initiated by a human dialing out to a calling center or engaging with a chatbot on a website. However, in other instances, the conversation between the human and the AI Agent may be initiated by either party.

In the instance of a phone conversation, when the human speaks, their speech is converted to text continuously during the entirety of the conversation. This text is then input into an intent engine to be matched against a database of keywords and phrases; if the semantic elements of the conversation are recognized as corresponding to a scenario which necessitates transfer to a another, second agent, the first AI Agent may initiate a “graceful” transfer process to that second agent.

The database used to learn the intent of the human may include a relational database that contains semantic elements such as keywords or phrases that map to an intent, string similarity or embedding-enabled schema, or more complex processing such as machine learning models that learn human intent patterns over time.

Instead of converting speech to text, a speech-to-speech model can be trained to recognize semantic elements directly from an audio representation of the conversation, without first converting to text

The addition of a second agent to a conversation can be graceful. With such a graceful transfer, the first AI agent maintains a continuous presence with the human caller by remaining engaged in conversation with the human caller until the second agent is available. During this time, the initial AI agent can continue to process the conversation, engage in “small talk”, or even ask questions that are relevant to the intent in an effort to collect additional information including detection of further semantic elements of the conversation to assist the second agent. In this way, the human caller is never “left on hold” and always has a continuous presence with at least one agent.

In another embodiment, the initial agent may optionally initiate a transfer immediately. For example, this may happen when a particular human is calling (who can be identified via caller ID, voice identification, or by the AI agent asking the human caller for their name.)

The graceful transfer can have several characteristics such that the human caller is not aware that a transfer is in process, until the second agent is actually connected and on the line. For example, the AI agent can carry on a conversation with the human caller about their concern, or make “small talk” about the weather, or sports teams, or what they are planning to do later that day, etc. Optionally, the AI agent may be so adept at carrying on a conversation that the human isn't necessarily aware they are talking to an AI agent. This avoids a situation where the human caller is on hold or otherwise perceives they are being ignored. In this way, the waiting period for the second agent to get up to speed and come on line can be hidden from the human.

In another optional process, the second agent can be made aware of the context of the human caller before they actually connect. This can be accomplished by the AI agent passing along information that it has learned from the caller to the second agent in the background, in such a way that the human caller is not aware.

In another example of an instance of a phone conversation, a quick transfer can be made. For example, If the human says a certain phrase, that can trigger immediate transfer to a specific type of agent. This can also be triggered by detecting other than the linguistic aspects of speech—such as by detecting emotion (user is “angry” or “impatient”). It should be understood, therefore, that the reference herein to detecting semantic elements of the conversation can extend to paralinguistics—aspects of the speech beyond the keywords and phrases, e.g., beyond the linguistic content.

In another example instance of a text conversation, the text is input into an intent engine to be matched against a database of keywords and phrases; if the text is recognized as matching a scenario which necessitates transfer to a human agent, the AI Agent may initiate a graceful transfer process.

In another example instance of a text conversation, the text is input into an intent engine to be matched against a database of keywords and phrases; if the text is recognized as matching a scenario which necessitates assistance from a human agent, the AI Agent may initiate the process of adding a human agent to the conversation.

Once it has been determined by the AI Agent that a human agent is needed, the graceful transfer or addition process may be initiated. The AI Agent checks to see which human agents are available for the conversation. Among the available human agents, the AI Agent may optionally determine which human agent would best be able to handle the request from the human. The AI Agent may notify the chosen human agent that they are needed for the conversation and provide the human agent with a voice and/or text summary of the conversation.

The AI Agent may determine which human agent is best for the conversation based on the skills of the human agent and other considerations. The AI Agent may determine which skills are needed for the conversation by inputting the text of the conversation into an intent engine to determine the overall user goal.

In the instance where the human agent is not available in a timely manner, the AI Agent may continue interacting with the human in such a way to mimic natural conversation until the human agent is available.

In the instance where the AI Agent has determined that a human agent is needed, but it is expected that additional information is needed from the human to complete their request, the AI Agent may continue the conversation with the human to ascertain this information while the transfer or addition of the human agent is in process.

In the instance of a phone conversation, the AI Agent may transfer the conversation to a human agent that continues in the form of a text conversation.

In the instance of a text conversation, the AI Agent may transfer the conversation to a human agent that continues in the form of a phone conversation.

The conversation between the human and the AI Agent may be a combination of human voice and human text, as well as an AI Agent utilizing voice and text, during the entirety or different points in the conversation.

In the instance of a phone or text conversation where the AI Agent has transferred to a human agent, the AI Agent may continue to monitor the conversation.

In the instance of a phone or text conversation, where the AI Agent has transferred to a human agent, the human agent may decide to transfer the conversation back to the AI Agent.

It is also contemplated that the second agent may not be able to address the intent of the human. In this instance, the second agent maintains continuous presence and continues to engage with the human until a further intent can be determined and a subsequent agent is available.

The foregoing examples have been described in the context of conventional telephone conversations or text message exchanges on mobile devices. However, the same principles are equally applicable to other communication channels. For example, a “telephone” conversation may occur over a Voice over IP (VoIP) connection, through mobile applications, via websites or web applications, or within video call platforms such as WeChat, Skype, Zoom, etc.

Example processes and systems for implementing these features are now described in connection with the figures.

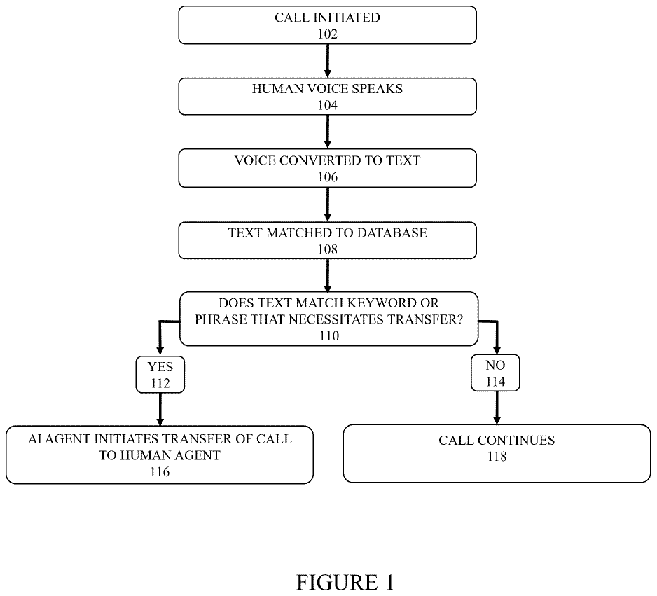

FIG. 1 is a process diagram illustrating an example of how to determine when to transfer a voice conversation to a human agent. In a first state 102 a call is initiated between a human caller and an initial AI agent. Eventually the human caller speaks in state 104. The voice is then converted to text is state 106. The text is matched to a database of keywords and phrases in state 108. A is then performed in state 110. If the text does not mention keyword or phrase that necessitates transfer to another agent, then the process continues to state 114 and state 118 with the human continuing to speak with the initial AI agent. If however, in state 110, there is a keyword or phrase match at state 112 the AI agent initiates graceful transfer of the call to another agent at state 116, who may be a human agent.

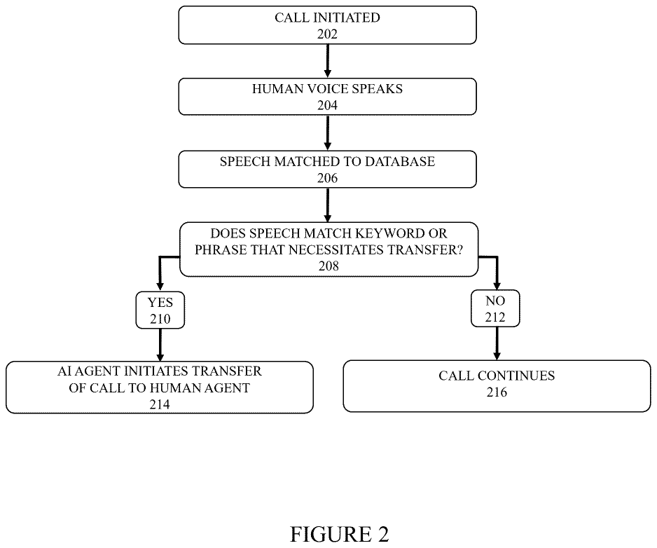

FIG. 2 is an example process diagram illustrating an example of how to determine when to transfer a voice conversation to a human agent with speech. At state 202 a conversation between a human caller and an initial AI agent is initiated. The human speaks at state 204 and their speech is matched to a keyword and phrase database at state 206. A test is made to determine whether the speech matches and keywords, or phrases that necessitate transfer at state 208. If there are no matches or transfer is not indicated at state 212, the call continues at state 216 with the initial AI agent and the human caller still connected. If however, there is a match at state 210 then the AI agent initiates transfer of the call to a human agent at state 214.

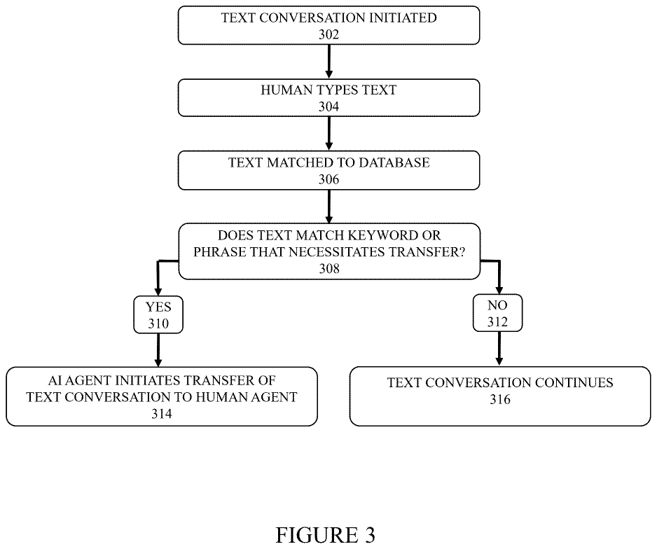

FIG. 3 is a process diagram illustrating an example of how to determine when to transfer a text conversation to a human agent. At an initial state 302 a text conversation is started. At state 304 the human types text and at state 306 the text is matched to a database of keywords or phrases. At state 308 a test is performed to see if there is a match to any keywords or phrases. At state 312 if there is no match then the process continues to state 316 with the text conversation still being enabled with the initial AI agent. If however, there is a match then in state 310 the AI agent initiates transfer of the text conversation to another agent such as a human agent at state 314.

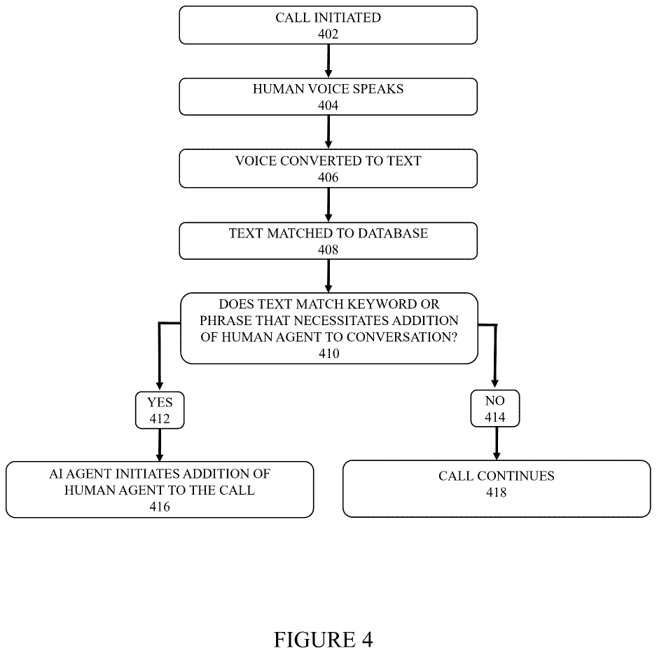

FIG. 4 is an example process diagram illustrating an example of how to determine when to add a human agent into a voice conversation. State 402 is an initial state where the call is started. At state 404 a human voice is detected and at state 406 the voice is converted to text. At state 408 the text is matched to a database of keywords and phrases. A search is performed at state 410 to determine if the text matches any keywords or phrases that necessitate addition of a human agent to the conversation. If there is a matching at state 412 the process continues to state 416 where the AI agent initiates the addition of a human agent to the call in graceful manner. If however, there is no match in state 414 then the process continues with just the original AI agent at state 418.

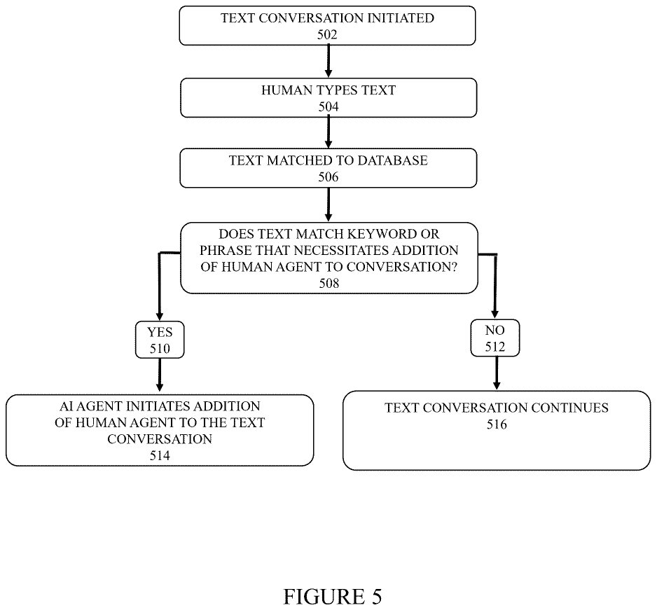

FIG. 5 is an example process diagram illustrating how to determine when to add a human agent to a text conversation. At state 502 the text conversation is initiated. At state 504 the human types text and at state 506 the text is matched against a database of keywords and phrases. If there is a match that indicates the need to add a human agent to the conversation at state 508, the process continues to state 510 and at state 512 a human agent is added to the conversation. If there is no match at state 512 the text conversation continues at state 516, with the human texting with the original AI agent.

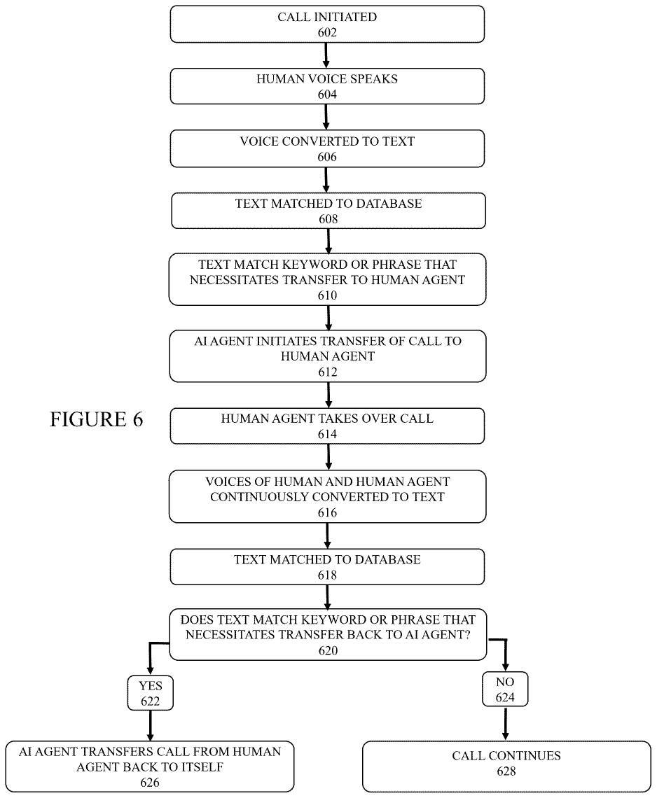

FIG. 6 is a process diagram illustrating an example of how to determine the intent of an initial human agent to transfer a conversation back to an AI agent. At state 402 the call is initiated. As a human voice speaks at state 604 the voice is converted to text at state 606, and the is text matched to database of keywords and phrases at state 608. If, at state 610, the text matches a keyboard or phrase, then the initial AI starts a transfer of the call to a human agent at 612 at then to state 614, where the human agent takes over the call. While the call continues the voices of the human and human agent are continuously converted to text at state 618. Such text is also continuously matched to a database at state 618—if the text matches a keyword or phrase that necessities transfer back to an AI agent at state 620, then the call is transferred from the human agent back to the AI agent at state 626. However, there is no such indication at state 620, then at state 624 the call continues at state 628 between the human agent and the caller.

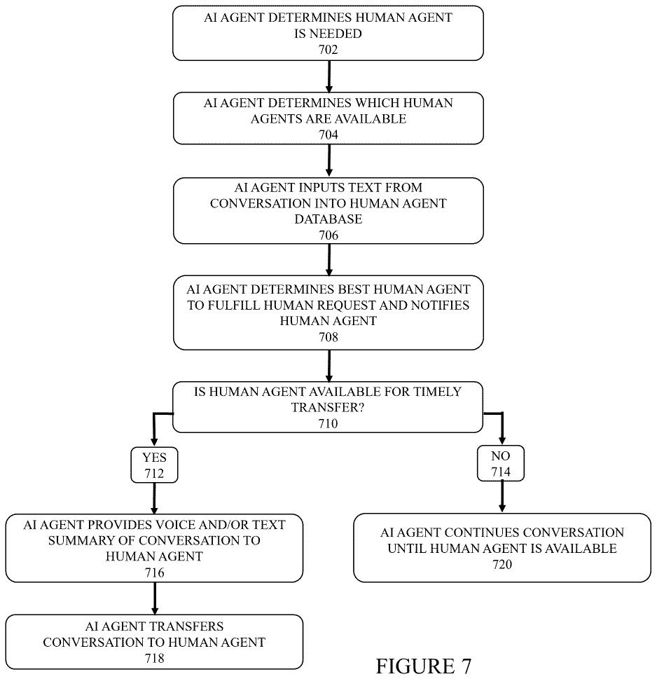

FIG. 7 is a process diagram illustrating a example of a graceful transfer process. Here a conversation has already begun between an AI agent and a human agent. At state 702 the AI agent determines that a human agent is needed to take over the call. The AI agent determines which human agents are available in state 704. This may be accomplished for example at state 706 with the AI agent submitting text from the conversation and to the AI agent to a database at state 708. The database search determines a best fit for one of several possible human agent to join the call. At state 710 it is determined if the human agent that was identified in the database is actually available for a timely transfer. If at state 712 the human agent is available, then a voice and/or text summary of the conversation is provided to the human agent at state 716. The AI agent transfers the conversation to the human agent at state 718 in a graceful manner, by maintaining continuous presence, as described above. if however, back at step 710 if the identified human agent is not available, then at state 714 the AI agent will continue the conversation until some other human agent is available at state 720. This further provides the desired graceful experience to the users such that they are never left on hold.

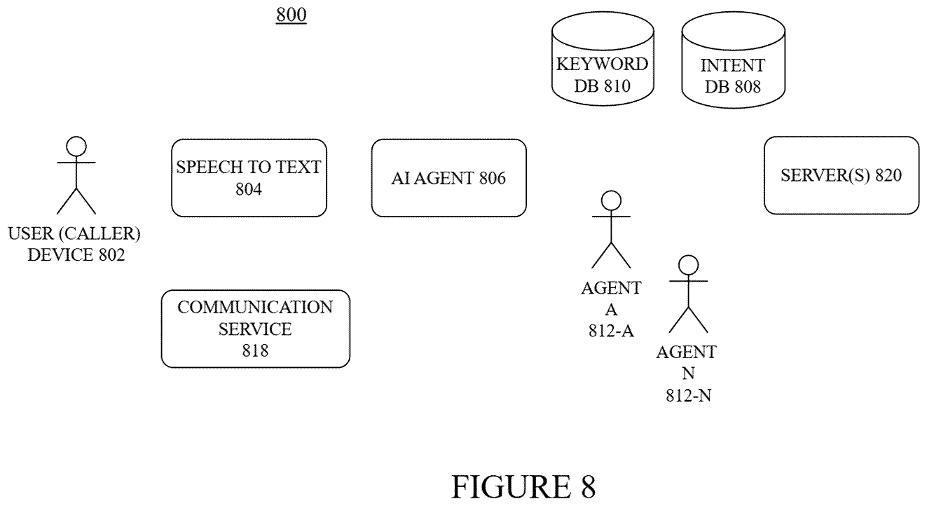

FIG. 8 is an example of a system 800 in which any of the processes described herein may be implemented. The components consist of one or more server(s) 820, databases 808, 810, a communication service 818, user devices 802 that can receive telephone calls, video calls, and/or SMS messages, and, in some embodiments, operate a smartphone application.

The communication service 818 enables the system 800 to handle calls from and to and/or send/receive text messages between users and agents 806, 812-A, 812-N. It may make connections via a telephone network, cellular network, Voice over IP, web applications, mobile applications or in other known ways.

The server(s) 820 access/update data in the databases 808, 810 and control the communication service 818 such as via its APIs. The server(s) 820 also instructs the AI Agent 806 and other Agents 812-A, 812-N how to respond to calls and/or text messages.

Users device 802 makes or receives traditional telephone calls and/or SMS messages as controlled by the communication service 818 (as instructed by the server 820). In some embodiments, user devices 802 are optionally a smartphone having one or more installed applications to facilitate video calls and/or audio calls. In this case, a server side application running on a server 820 may orchestrate the smartphone application directly or via some other communication service.

In one example use of this system 800, a human caller using device 802 initiates connection to the system 800, such as via voice call or text. In the case of a voice call, the audio is processed by a speech to text component 804. An AI agent 806 is programmed to process and understand this text, such as to detect keywords or phrases, or even understand an intent of the caller. In particular AI agent 806 may match detected words or phrases to a keyword database 810. Database 810 contains keywords and phrases that assist the AI agent 806 or other agents in determining how to handle the call.

Also of assistance to the AI agent 806 is an intent database 808. The intense database 808 provides a second tier of processing of the conversation to determine greater meaning or intent of the caller 802 to better determine how to handle the call.

One or more agents 812-A through 812-N are various AI agents and or human agents that are trained or equipped to handle certain types of inquiries from caller 802.

Server 820 is a data processor and/or optional telephony interface that orchestrates these various components to perform the functions described—such as to connect the caller 802 to the initial AI agent 806, pass the converted speech to text so that the AI agent can submit queries to the databases 808, 810 or transfer the initial conversation to the other agents 812-A, 812-N as required.

The intent database 808 may include one or more tables that map semantic elements detected from the conversation(s) to an intent and also to a type of second agent 812. Below is an example table:

| | | Second Agent |
|---|---|---|
| Intent Name | Semantic Elements | Type |
| Pay Bill | I would like to pay my over | Billing Specialist |
| | due bill | |
| Pay Bill | What is my outstanding balance | Billing Specialist |
| Dispute Charges | I was over charged on my last | Billing Specialist |
| | bill | |
| Move Account | I moved recently, need to | Account Specialist |
| | transfer my service | |
| Cancel Accounts | I want to cancel my service | Account Specialist |
| Network Issues | My internet is very slow | Network Specialist |
| Poor Picture | The picture on my TV is very | Network Specialist |
| Quality | blurry | |
| . . . | . . . | . . . |

For example, if the human caller speaks “What is my outstanding balance”, this semantic maps to a certain type of second agent 812—a Billing Specialist—who is the appropriate agent to further handle the call.

It should be noted that a given type of agent may handle more than one intent, and an intent may have more than one corresponding semantic element. For example, an Account Specialist may handle requests to transfer service or cancel service, and a Network Specialist may handle requests to address slow internet connection or blurry television reception.

It should be understood that the intent name field may correspond to an organizational shorthand. It is also possible that the database contains a direct mapping between semantic elements and a second agent type without an intent name relation.

As mentioned briefly above, the intent of the human may be determined from semantic elements of the conversation, such as keywords or phrases stored in the intent database 808. However, other attributes of the conversation, so-called paralinguistic features, may also be detected. These could include detecting emotions such as stress, anger, or anxiety in the human's voice, which can further assist with finding the best second agent 812.

Strings of text taken from the conversation may be searched within the databases 808,810 to locate similar text strings that indicate intent.

In other implementations, intent is determined by computing one or more embeddings from semantic elements and applying applies a similarity measure (e.g., cosine similarity, Euclidean distance, etc.). Unlike string-matching techniques, this embedding-based approach enables identification of semantically related concepts even where no shared keywords exist. A typical embedding is a numerical representation of textual data in a high-dimensional vector space. Words, phrases, or sentences that share similar meanings are placed closer together in this vector space, based on statistical patterns learned from large datasets.

The following are examples of verbal and/or text exchanges between a human and various types of agent(s).

### Example 1: AI Agent Transfers Phone Conversation to Human Agent

CALL INITIATED

AI AGENT: Hello my name is [NAME] calling on behalf of [ORGANIZATION]. May I know who I am speaking with?

HUMAN: This is [NAME] what is this call about?

AI AGENT: Hi [NAME]I am calling today because there appears to be fraudulent activity on your [ORGANIZATION] account.

HUMAN: Okay what's going on?

AI AGENT: There is a charge for $XXXX from [RETAILER] is this a purchase you made?

HUMAN: No I didn't make that purchase.

AI AGENT: Okay let me transfer you to a fraud specialist to handle this matter. Please hold.

AI AGENT INITIATES GRACEFUL TRANSFER PROCESS OF CALL TO HUMAN AGENT

### Example 2: AI Agent Adds Human Agent to Phone Conversation; Human Agent Transfers Phone Conversation Back to AI Agent

CALL INITIATED

AI AGENT: Hello my name is [AI AGENT NAME] calling on behalf of [ORGANIZATION]. May I know who I am speaking with?

HUMAN: This is [HUMAN NAME] what is this call about?

AI AGENT: Hi [HUMAN NAME]I am calling today to see if you would be interested in upgrading your [SERVICE] with [ORGANIZATION].

HUMAN: Yes I would be interested in upgrading. What would be the cost?AI AGENT: Great! The cost would be $XXX.

HUMAN: Hmmm that is a bit high. I've been a customer of [ORGANIZATION] for 10 years, is there a possible discount?

AI AGENT: Let me bring on my supervisor to see if we can accommodate that.

AI AGENT INITIATES GRACEFUL PROCESS OF ADDING HUMAN AGENT TO THE CALL

AI AGENT DETERMINES WHICH AVAILABLE HUMAN AGENT IS BEST QUALIFIED FOR THE CALL AND NOTIFIES THE HUMAN AGENT

AI AGENT PROVIDES TEXT AND/OR VOICE SUMMARY OF THE CALL TO HUMAN AGENT

HUMAN AGENT JOINS THE CALL

HUMAN AGENT: Hi this [HUMAN AGENT NAME].

AI AGENT: Thanks for joining this call [HUMAN AGENT NAME]. I have been speaking with [HUMAN NAME] about upgrading their service. They have been a loyal customer of ours for 10 years and wanted to know if we could offer a discount on [SERVICE].

HUMAN AGENT: Yes we can offer a $XX discount. AI AGENT: [HUMAN NAME] how does that sound? HUMAN: That works for me!

HUMAN AGENT: Great![AI AGENT NAME] can you take it from here?AI AGENT: Yes I got it!

HUMAN AGENT: Nice to meet you [HUMAN NAME] take care goodbye!HUMAN AGENT LEAVES THE CALL

AI AGENT: [HUMAN NAME] you will see the upgraded [SERVICE] charge appear on your future bill. Do you have any questions or is there anything else I can help you with?

HUMAN: No I'm all set.

AI AGENT: Great! Enjoy the rest of your day! HUMAN: Okay bye.

CALL IS ENDED

### Example 3: AI Agent Transfers Phone Conversation to Human Agent that is not Immediately Available

CALL INITIATED

HUMAN: Hi this is [HUMAN NAME]I am calling because there is a discrepancy in my last bill.

AI AGENT: Hi [HUMAN NAME] thank you for calling [ORGANIZATION] this is [AI AGENT NAME]. We can certainly help you with that issue. Can you tell me more about what the discrepancy in the bill is?

HUMAN: Yes I applied for a discount that I qualify for but it was not reflected in my bill.

AI AGENT DETERMINES HUMAN AGENT IS NEEDED AND INITIATES GRACEFUL TRANSFER PROCESS OF CALL TO HUMAN AGENT

AI AGENT DETERMINES WHICH AVAILABLE HUMAN AGENT IS BEST QUALIFIED FOR THE CALL AND NOTIFIES THE HUMAN AGENT

AI AGENT IS ALERTED OF WAIT TIME FOR HUMAN AGENT AND CONTINUES CALL WITH HUMAN

AI AGENT: Okay we will do our best to resolve this issue. Can you tell me what the specific discount is that you applied for?

HUMAN: Yes I applied for a XX % discount that is supposed to be applied to the bill I just received.

AI AGENT: I see. This is an issue that is best handled by our billing department. I have reached out to them and they will let me know shortly when they are ready to speak with you.

HUMAN: Okay.

AI AGENT: How is your day going?

AI AGENT HAS BEEN ALERTED THAT HUMAN AGENT IS READY FOR CALL AND WRAPS UP CONVERSATION

HUMAN: It's been good. How about you?AI AGENT: It's been good thank you!

AI AGENT: I've just been informed that [HUMAN AGENT NAME] from billing is available, I am transferring the call now.

AI AGENT PROVIDES TEXT AND/OR VOICE SUMMARY OF THE CALL TO HUMAN AGENT

AI AGENT TRANSFERS CALL TO HUMAN AGENT

### Example 4: AI Agent Adds Human Agent to Phone Conversation while Gathering Additional Information

CALL INITIATED

HUMAN: Hi this is [HUMAN NAME]I am calling because I would like to upgrade my [SERVICE].

AI AGENT DETERMINES HUMAN AGENT IS NEEDED AND INITIATES ADDITION OF HUMAN AGENT TO THE CALL

AI AGENT DETERMINES WHICH AVAILABLE HUMAN AGENT IS BEST QUALIFIED FOR THE CALL AND NOTIFIES THE HUMAN AGENT

AI AGENT PROVIDES TEXT AND/OR VOICE SUMMARY OF THE CALL TO HUMAN AGENT

HUMAN AGENT JOINS THE CALL

AI AGENT: Hi [HUMAN NAME] thank you for calling [ORGANIZATION] this is [AI AGENT NAME]. We can certainly accommodate your request. Can you tell me more about what you need from [SERVICE]?

HUMAN: Yes I am currently using [SERVICE] once a month but would like to increase that to twice a month.

AI AGENT: Okay got it. [HUMAN AGENT] has just joined the call and they can assist you with this upgrade.

HUMAN AGENT TAKES OVER CALL

### Example 5: AI Agent Transfers Text Conversation to Human Agent

TEXT CONVERSATION INITIATED

AI AGENT: Hello my name is [NAME]. What can I help you with today?

HUMAN: I want to cancel my [SERVICE] with [ORGANIZATION] it is too expensive.

AI AGENT: I can assist you with that. I am sorry to learn that you want to cancel your service. I can offer an immediate $XX discount on [SERVICE], would you like to move forward with that?

HUMAN: No I still want to cancel my service.

AI AGENT: Understood, I am transferring you to an account specialist who can assist you with that. Have a wonderful rest of your day!

AI AGENT INITIATES GRACEFUL TRANSFER OF TEXT CONVERSATION TO HUMAN AGENT

### Example 6: AI Agent Transfers Text Conversation to Human Agent in the Form of a Phone Conversation

TEXT CONVERSATION INITIATED

AI AGENT: Hello my name is [NAME] calling from [ORGANIZATION]. We noticed that your warranty on [PRODUCT] is expiring at the end of the month, would you be interested in extending it?

HUMAN: I am not sure. I would like to know what my options are for extending my warranty and costs.

AI AGENT: We can assist you with that. One of our warranty specialists will be contacting you by a phone call shortly to go over your options.

AI AGENT INITIATES GRACEFUL TRANSFER OF TEXT CONVERSATION TO HUMAN AGENT IN THE FORM OF A PHONE CALL

### Further Implementation Options

The foregoing description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, and data processing systems, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

It should be understood that the example embodiments described above may be implemented in many different ways. In some instances, the various “data processors” may each be implemented by a physical or virtual general purpose computer having a central processor, memory, disk or other mass storage, communication interface(s), input/output (I/O) device(s), and other peripherals. The general-purpose computer is transformed into the processors and executes the processes described above, for example, by loading software instructions from a memory into the processor, and then causing execution of the instructions to carry out the functions described. Network interface(s) allow connections to various other devices attached to a network.

One or more memories provide volatile and/or non-volatile storage for computer software instructions and data used to implement an embodiment. Disks or other mass storage provides non-volatile storage for computer software instructions and data used to implement, for example, the various procedures described herein. Such a computer program product can be installed by any suitable software installation procedure, as is well known in the art. In another embodiment, at least a portion of the software instructions may also be downloaded over a cable, communication and/or wireless connection.

Embodiments may therefore typically be implemented in hardware, custom designed semiconductor logic, Application Specific Integrated Circuits (ASICs), Field Programmable Gate Arrays (FPGAs), firmware, software, or any combination thereof.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and system diagrams may include more or fewer elements, be arranged differently, or be represented differently. But it further should be understood that certain implementations may dictate the block and network diagrams and the number of block and network diagrams illustrating the execution of the embodiments be implemented in a particular way.

Further embodiments may also be implemented in a variety of computer architectures, physical, virtual, cloud computers, mobile devices, laptops, servers, tablets, and/or some combination thereof, and thus the computer architectures described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. An automated method comprising:
connecting a human and a first AI agent in a conversation;
determining a necessity for involving a second agent in the conversation; and
until the second agent is available, the first AI agent maintains continuous presence with the human.

2. The method of claim 1 additionally comprising:
determining an intent of the human indicating why the human joined the conversation; and
determining, based on the intent, which of one or more other agents are selected as the second agent.

3. The method of claim 1 wherein the intent of the human is determined from semantic elements of the conversation that match keywords or phrases.

4. The method of claim 1 wherein the intent of the human is determined from semantic elements of the conversation that comprise paralinguistic features.

5. The method of claim 1 wherein the intent of the human is determined by locating a semantic element from the conversation with an intent database.

6. The method of claim 1 wherein the intent of the human is determined by determining similarity of a text string from the conversation against text strings in an intent database.

7. The method of claim 1 wherein the intent of the human is determined by computing one or more embeddings from semantic elements in the conversation and applying a similarity measure.

8. The method of claim 1 wherein the conversation is a telephone call.

9. The method of claim 1 wherein the conversation is a text message.

10. The method of claim 1 additionally comprising:
the first AI agent continues to interact with the human in the conversation in such a way to mimic natural conversation until the second agent is available.

11. The method of claim 1 additionally comprising:
converting audio from the conversation into text before determining the intent of the human.

12. The method of claim 1 wherein the first AI agent asks for additional information from the human until the second agent is available.

13. The method of claim 1 additionally comprising:
enabling the second agent to engage in the conversation;
determining that the second agent is not able to address the intent of the human; and
the second agent maintaining presence with the human until a subsequent agent is available.

14. The method of claim 1 additionally comprising:
before or when the second agent joins the conversation, a summary of the conversation between the first AI agent and the human is provided to the second agent.

15. The method of claim 1 wherein the second agent is a human.

16. The method of claim 1 wherein the second agent is an AI agent.

17. The method of claim 2 wherein semantic elements of the conversation are determined with a speech to speech language model.

18. An electronic data processing system, comprising:
a hardware processor; and
computer memory holding computer program instructions executed by the hardware processor, with the computer program instructions configured for:
connecting a human and a first AI agent in a conversation;
determining a necessity for involving a second agent in the conversation;
determining which of several other agents are an appropriate second agent; and
until the second agent is available, the first AI agent maintaining continuous presence with the human.
